(19) United States
(12) Patent Application Publication
(10) Pub. No.: US 2026/0312331 A1
(43) Pub. Date: Oct. 8, 2026

(54) SEALABLE CONNECTOR ARRANGEMENT

(71) Applicant: Aptiv Technologies AG, Schaffhausen (CH)

(72) Inventors: Mirko POSMIK, Fürth (DE); Rainer SCHMIDT, Nürnberg (DE)

(21) Appl. No.: 19/530,908

(22) Filed: Feb. 5, 2026

(30) Foreign Application Priority Data
Apr. 4, 2025 (EP) 25168453.6

(51) Int. Cl. H01R 13/52

(52) U.S. Cl. CPC H01R 13/5202

(57) ABSTRACT

A sealable connector arrangement includes a seal with at least one fixing element and a connector housing with a reception space for receiving the seal. The reception space has an opening to receive the fixing element, securing the seal inside when mounted. The connector housing features a sloping wall adjacent to the opening, facilitating a tilting movement of the fixing element during insertion, thereby simplifying the mounting process of the seal onto the connector housing.

### CROSS-REFERENCE TO RELATED APPLICATION

This application claims the benefit of and priority to European Application No. 25168453.6 filed with the European Patent Office on Apr.4, 2025, the contents of which are incorporated by reference herein.

### TECHNICAL FIELD

The present disclosure generally relates to a sealable connector arrangement designed to enhance the security of seals within connector housings. Specifically, the disclosure pertains to a connector housing featuring a reception space with an opening for fixing elements for improved seal retention.

### BACKGROUND

In the field of connector arrangements, it is common to use seals to ensure a tight and secure connection between different components. Known systems typically involve seals that are mounted onto connector housings to prevent leakage and maintain the integrity of the connection. These seals often rely on various fixing elements to secure them in place within the connector housing. Traditional approaches include the use of snap-fit elements, which engage with corresponding openings in the housing to hold the seal securely. However, these systems can be prone to issues such as improper engagement, difficulty in assembly, and potential damage to the fixing elements during installation.

According to known systems, the fixing elements are often designed to fit tightly within the openings of the connector housing, which can lead to bending or deformation of the fixing elements during insertion. This can compromise the effectiveness of the seal and result in a less reliable connection. Additionally, the design of the connector housing and the seal can make the assembly process cumbersome and time-consuming, requiring precise alignment and forceful insertion to achieve a secure fit. These challenges are exacerbated when dealing with seals that have complex geometries or multiple fixing elements, further complicating the installation process. FIG. 1A illustrates a prior art sealable connector arrangement. A connector housing 40 is depicted as having multiple cylindrical openings for the reception of electrical contacts. The housing 40 includes a reception space 43, which is intended to accommodate a seal 50.

The seal 50 is an axial seal and shown as a generally flat, rectangular frame with four fixing elements 51 extending downward from its corners. These fixing elements 51 are designed to engage with the connector housing 40 to secure the seal 50 in place. The fixing elements 51 have arrowhead shaped ends, which are intended to fit into four corresponding holes 41 in the reception space 43 of the connector housing 40. These holes 41 (of which only one is visible due to the perspective) are designed with a smaller diameter than the arrowhead shaped end of the fixing elements 51.

FIG. 1B illustrates how the seal 50 is mounted onto the housing 40. FIG. 1B shows mounting tools 52, which push the seal 50 downwards and press the fixing elements 51 into the respective holes 41. As the arrowhead shaped ends of the fixing elements 51 are slightly larger than the holes, relatively large forces must be applied to press the elements 51 into the holes 41. This leads to a strong connection; however it bears the risk of damaging the delicate seal during the mounting process and it is only suitable for arrangements, in which the mounting tools 52 can engage the seal 50 close to the position of the fixing elements 51. Thus, it is not well suited for radial seals, which tend to have much larger dimensions in axial direction (i.e., in mounting/insertion direction).

Despite the substantial advances in the field of sealable connector arrangements, there remains a need for improved systems that offer easier assembly, reliable engagement of fixing elements, and enhanced sealing performance.

### SUMMARY

It is an object of the present disclosure to provide an improved sealable connector arrangement that facilitates assembly and reliably secures a seal within a connector housing.

According to one aspect of the disclosure, a sealable connector arrangement comprises a seal having at least one fixing element and a connector housing having a reception space for receiving the seal. The reception space includes an opening configured to receive the fixing element when the seal is mounted onto the connector housing to secure the seal within the reception space. The connector housing further includes a sloping wall adjacent to the opening; the sloping wall being configured to induce a tilting movement of the fixing element upon insertion of the fixing element into the opening.

In one embodiment, the fixing element comprises a hook having a generally L-shaped geometry. The hook is configured such that it does not engage the connector housing in a fastening relationship when untilted and engages an edge of the opening only after being tilted by interaction with the sloping wall.

In a further embodiment, the opening is larger than the hook, allowing the fixing element to be inserted into the opening without substantial bending. The fixing element may extend from a main body of the seal in an insertion direction of the seal, with the hook oriented outwardly from the seal. The fixing element is not a snap-fit element.

In another embodiment, the sloping wall is arranged behind the opening as viewed in the insertion direction of the seal, such that the fixing element is tilted only after at least partial insertion into the opening. The opening may be formed as a through hole, with the hook engaging an exit edge of the through hole when tilted.

In yet another embodiment, the seal includes at least one outer circumferential lip and may include two outer circumferential lips separated by a circumferential recession. The seal may be configured as a radial seal adapted to exert radial pressure when the connector housing is mated with a counter connector housing.

In a further embodiment, the reception space of the connector housing is free of undercuts to facilitate injection molding. The seal may have an essentially rectangular cross-section in a plane perpendicular to the insertion direction, with fixing elements arranged at corner portions of the seal.

### BRIEF DESCRIPTION OF THE DRAWINGS

Other features, details, and advantages of the disclosure will become more apparent from the detailed illustrative description given hereafter with respect to the drawings in which:

FIG. 1A shows an isometric view of a sealable connector arrangement according to the prior art.

FIG. 1B shows an isometric view of the sealable connector arrangement of FIG. 1A in assembled condition according to the prior art.

FIG. 2A shows an isometric view of a seal with fixing elements from a first perspective according to some embodiments.

FIG. 2B shows an isometric view of the seal of FIG. 2B from a second perspective according to some embodiments.

FIG. 3A shows an isometric view of a connector housing according to some embodiments.

FIG. 3B shows an isometric view of a detail of the connector housing of FIG. 3A according to some embodiments.

FIG. 4 shows a bottom view of the connector housing of FIG. 3A according to some embodiments.

FIG. 5 shows a cross-sectional side view of a sealable connector arrangement according to some embodiments.

FIG. 6 shows a cross-sectional side view of the sealable connector arrangement of FIG. 5 with the fixing elements partially inserted into the openings according to some embodiments.

FIG. 7 shows a cross-sectional side view of the sealable connector arrangement of FIG. 5 with the seal in its final position inside the housing according to some embodiments.

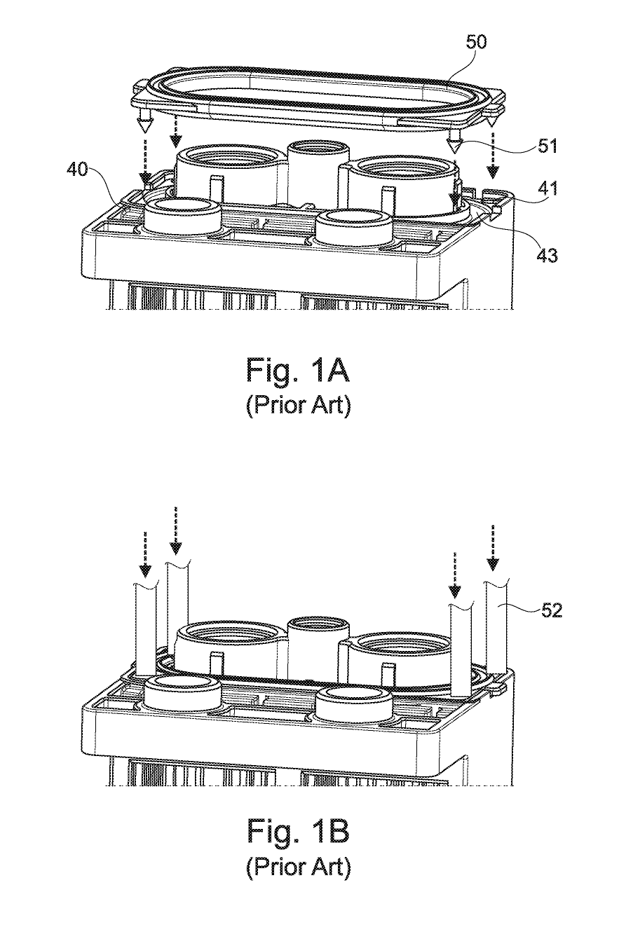

### DETAILED DESCRIPTION

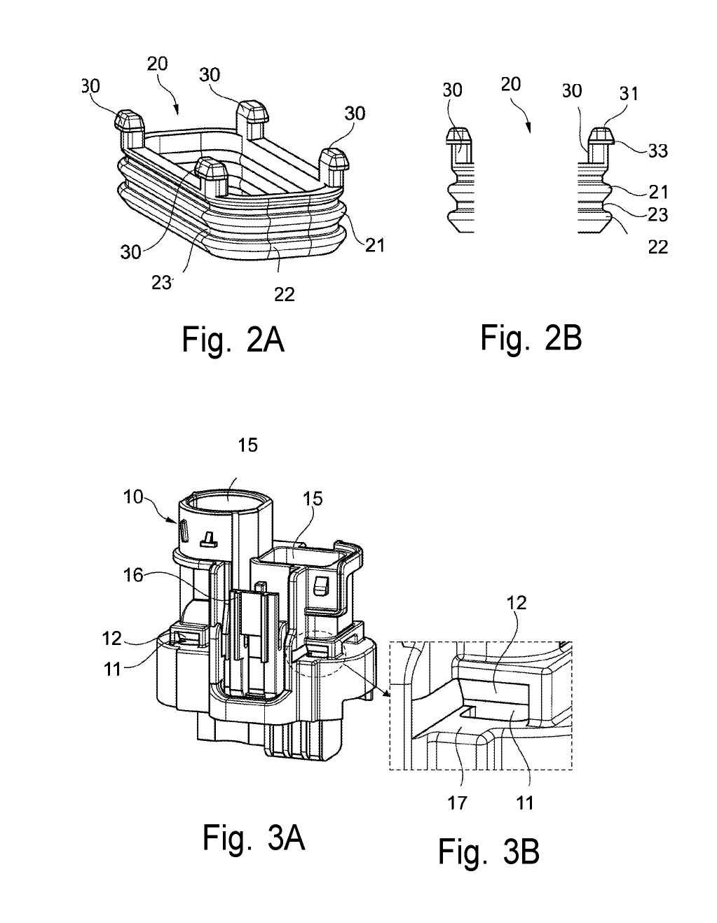

FIGS. 2A and 2B illustrate an embodiment of an inventive seal 20. FIG. 2A shows the seal 20 in a three-dimensional perspective view and FIG. 2B shows the seal in a front view.

The seal 20 generally has a rectangular cross-section, as evidenced by its elongated form with defined corner portions. Extending from these corner portions are four fixing elements 30, which are integral to the seal's design. The fixing elements 30 are shown to extend in the insertion direction, which is indicated by the arrow in FIG. 5.

The seal 20 is further detailed with outer, parallel, circumferential lips 21 and 22. The lips 21 and 22 are separated by a parallel, circumferential recession 23, which is configured to partially accommodate the lips when the seal is mounted, and the connector housing is mated with a counter connector. This design aspect allows for compression and expansion of the lips 21 and 22 into the recession, enhancing the sealing effect when the seal is in its operational position.

FIG. 2B provides a side view of the seal 20, offering a clearer view of the fixing elements 30 and their structural configuration. The fixing elements 30 are shown to include hooks 31, which are designed to engage with a connector housing. The hooks 31 exhibit generally L-shaped geometry. The distal end of each hook 31 is oriented outwardly from the seal, and the hooks include engagement faces 33. This outward orientation is advantageous, as it facilitates the engagement of the hooks with the edges of openings in the connector housing, as will be described in more detail below.

As the skilled person will recognize, the seal 20 is designed to function as a radial seal. This is inferred from the arrangement of the circumferential lips 21 and 22 and the relatively large height in axial direction. The seal is configured to be pressed in a radial direction when the connector housing is mated with a counter connector housing. The radial pressure enhances the sealing effect, ensuring that the connector arrangement remains leak-proof under operational conditions.

FIGS. 3A and 3B illustrate a connector housing 10 designed to accommodate the seal 20. The housing 10 includes cylindrical structures or cable receiving openings 15. Adjacent to the cylindrical structure 15, the housing 10 features a reception space intended for the insertion and securement of the seal 20, although the seal itself is not depicted in FIGS. 3A and 3B.

The housing 10 incorporates four openings 11 (only two of which are visible due to the perspective), which are positioned to allow the insertion of the four fixing elements 30. FIGS. 3A and 3B also highlight sloping walls 12, situated adjacent to the openings 11. Each sloping wall 12 is specifically designed to facilitate a tilting movement of the fixing element as it is inserted into the opening 11.

The detailed view of FIG. 3B emphasizes the interaction between the sloping wall 12 and the opening 11. The sloping wall 12 is positioned behind the opening 11, relative to the insertion direction of the seal, ensuring that the fixing element only undergoes a tilting movement after at least a partial insertion into the opening 11.

The housing 10 further includes fixing clamps 16, which serve to fix the housing onto a corresponding counter connector housing upon mating.

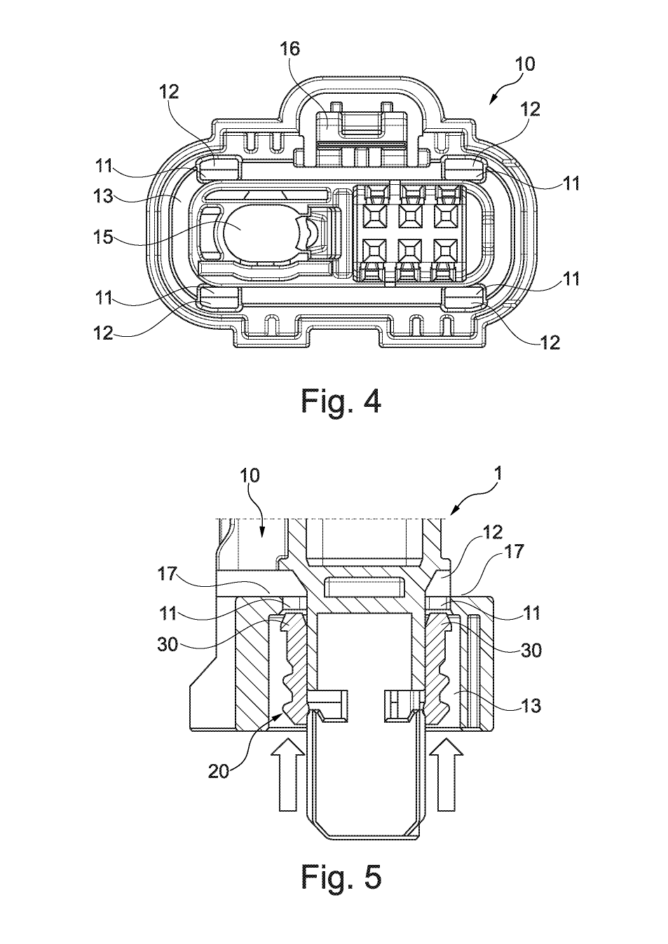

FIG. 4 shows the connector housing 10 in a bottom view. The housing 10 includes four openings 11 positioned to receive the fixing elements 30 of seal 20. Each opening 11 includes an adjacent sloping wall 12 which facilitates the tilting movement of the fixing elements upon insertion into the openings 11. The housing 10 features the reception space 13, which is intended to receive the seal 20. This reception space 13 is configured without any undercuts, thus facilitating the injection molding process.

FIGS. 5-7 illustrate the insertion or mounting process of the seal 20 into the reception space 13 of the housing 10.

FIG. 5 illustrates a sealable connector arrangement 10 including the connector housing 10 and the seal 20 in a cut view. The seal 20 is accommodated in the reception space 13 of the housing 10 but not yet attached thereto. The two arrows indicate the direction of insertion of the seal 20. The reception space 13 features four openings 11 (only two of which are visible in the cut view of FIG. 5) intended for the insertion of the fixing elements 30.

Adjacent to the openings 11, the connector housing 10 incorporates sloping walls 12. The sloping walls 12 are designed to facilitate the tilting movement of the fixing elements 30 as they are inserted through the respective openings 11. The sloping walls 12 are positioned behind the openings 11, relative to the insertion direction of the seal 20 into the reception space 13. The openings 11 are formed as through holes in the wall of the connector housing 10.

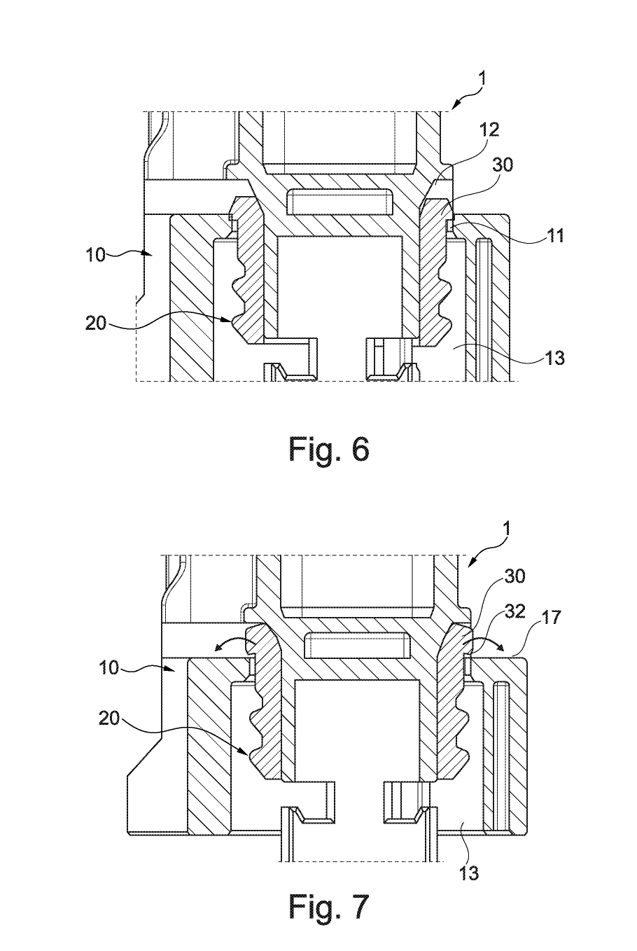

In FIG. 6 the seal 20 is further inserted into the housing 10 and the fixing elements 30 are now partly inserted into the respective openings 11. The fixing element 30 is not yet tilted and not engaged in a fastening relationship with the housing 10. Only upon further insertion, the sloping wall 12 induces a tilting movement in the fixing element 30, bringing it into engagement with an edge of the opening 11. Thus, the fixing element 30 is not a snap-fit element but requires the tilting force transferred by the sloped wall.

As one can take from FIG. 6, the openings 11 in the connector housing 10 are larger than the arrowhead of the fixing element 30, so that the fixing element can enter the opening 11 essentially unobstructed. Thereby, any undesired bending of the fixing element 30 upon initial insertion into the opening 11 is prevented. FIG. 7 shows the seal fully inserted and in its final position. The sloping walls 12 have tilted the fixing elements 30 as indicated by the arrows, such that the tilted fixing elements 30 now engage with the housing in a fastening relationship. More specifically, the fixing elements 30, respectively the hooks 31 thereof, engage with the exit edge 17 of the openings 11. This engagement ensures that the seal 20 remains securely in place within the connector housing 10, providing an effective seal for the connector arrangement.

While the invention has been described with reference to an exemplary embodiment(s), it may be understood by those skilled in the art that various changes may be made, and equivalents may be substituted for elements thereof without departing from the scope of the invention. In addition, many modifications may be made to configure a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It may also be understood that, although the terms first, second, etc., are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It may also be understood that the term “and/or” as used herein refers to and encompasses any and all possible combinations of one or more of the associated listed items. It may be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if a stated condition or event is detected” is, optionally, construed to mean “upon determining” or “in response to determining” or “upon detecting the stated condition or event” or “in response to detecting the stated condition or event,” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

### REFERENCE SIGN LIST

1 sealable connector arrangement

10 connector housing

11 opening

12 sloping wall

13 reception space

15 cable receiving openings

16 fixing clamp

17 edge of opening

20 seal

21 first circumferential sealing lip

22 second circumferential sealing lip

23 circumferential recession

30 fixing element

31 hook

33 engagement face of hook

50 axial seal

51 fixing pins

52 mounting tool

40 housing

43 reception for axial seal

1. A sealable connector arrangement, comprising:
a seal with at least one fixing element; and
a connector housing with a reception space for receiving the seal, which reception space comprises an opening to receive the fixing element, when the seal is mounted onto the connector housing for securing the seal inside the reception space; wherein the connector housing comprises a sloping wall adjacent to the opening, configured to facilitate a tilting movement of the fixing element upon insertion of the fixing element into the opening.

2. The sealable connector arrangement of claim 1, wherein the fixing element comprises a hook, the hook having a generally L-shaped geometry for engaging the housing.

3. The sealable connector arrangement of claim 2, wherein the hook is designed to not engage in a fastening relationship with the housing when untilted.

4. The sealable connector arrangement of claim 2, wherein upon being set into a tilting movement by the sloping wall, the hook is brought into engagement with an edge of the opening.

5. The sealable connector arrangement of claim 2, wherein the openings are larger than the hook, such that the fixing element is not bent upon initial insertion of the hook into the opening.

6. The sealable connector arrangement of claim 2, wherein the fixing element extends from a main body of the seal in insertion direction of the seal.

7. The sealable connector arrangement of claim 6, wherein the hook is oriented outwardly from the seal.

8. The sealable connector arrangement of claim 1, wherein the fixing element is not a snap-fit element.

9. The sealable connector arrangement of claim 1, wherein the seal comprises at least one outer circumferential lip.

10. The sealable connector arrangement of claim 9, wherein the seal comprises two outer circumferential lips, the lips being separated by a circumferential recession, which is configured to partially accommodate the lips in mounted condition of the seal.

11. The sealable connector arrangement of claim 1, wherein the sloping wall is arranged behind the opening when seen from an insertion direction of the seal into the reception space, such that the fixing element is only tilted after at least a partial insertion of the fixing element into the opening.

12. The sealable connector arrangement of claim 11, wherein the fixing element comprises a hook and is designed such that its distal end comes into contact with the sloping wall only after the hook has cleared the opening.

13. The sealable connector arrangement of claim 1, wherein the seal has an inner diameter of 10 to 30 mm.

14. The sealable connector arrangement of claim 1, wherein the seal has a height in an axial direction of 5-15 mm.

15. The sealable connector arrangement of claim 1, wherein the reception space for the seal in the housing does not have any undercuts to facilitate injection molding.

16. The sealable connector arrangement of claim 1, wherein the seal has an essentially rectangular cross-section in a plane perpendicular to an insertion direction, and fixing elements are arranged at corner portions of the seal, the fixing elements extending in insertion direction.

17. The sealable connector arrangement of claim 1, wherein the seal is a radial seal.

18. The sealable connector arrangement of claim 17, wherein the seal is designed to exert pressure in a radial direction when the connector housing is mated with a counter connector housing, to enhance a sealing effect.
